(19) United States
(12) Patent Application Publication
(10) Pub. No.: US 2015/0298373 A1
(43) Pub. Date: Oct. 22, 2015

(54) Method for producing a flat motor vehicle body member and motor vehicle body member

(71) Applicant: WEBASTO SE, Stockdorf (DE)

(72) Inventor: Frank KIESEWETTER, Stockdorf (DE)

(21) Appl. No.: 14/646,225

(22) PCT Filed: Nov. 21, 2013
(86) PCT No.: PCT/EP2013/074377

§ 371 Date: May 20, 2015

(30) Foreign Application Priority Data
Nov. 23, 2012 (DE) 10 2012 111 350.5

(51) Int. Cl. B29C 45/14; D06N 3/14; D06N 3/00

(52) U.S. Cl. CPC B29C 45/14786; D06N 3/00; D06N 3/14; B29K 2075/00

(57) ABSTRACT

A method for producing a vehicle body member formed from a flat plastics molded part. The method may include: producing a fiber composite member, which is formed from a flat semifinished product of fibrous material; arranging the fiber composite member in a mold cavity of an injection tool, such that an upper side of the fiber composite member, is spaced apart from a limiting surface of the mold cavity via a gap; introducing a coating material into the gap, such that a coating is formed at the upper side of the fiber composite member, which side is supposed to be coated; exerting a pressure on the coating material; hardening the coating material, such that an outer skin of the motor vehicle body member is formed from the coating; and demolding the resulting flat plastics molded part, which is formed from the fiber composite member and from the outer skin.

The invention relates to a method for producing a motor vehicle body member being formed from a flat plastics molded part, and to a motor vehicle body member.

From practice, motor vehicle body members being formed from a flat plastics molded part constituting a fiber composite piece, in particular a carbon fiber composite piece, are known. It is often desired that the carbon fiber composite piece is formed as a so-called viewing carbon member, in which the structure of a carbon inlay can be discerned from the outside. When producing such pieces, a fiber composite member, which prescribes the stiffness of the respective piece, is provided with multiple coats of paint in a laborious manner. In this manner, a high quality viewing surface can be produced, which can be employed as a so-called class A surface, even in the automotive industry. The painting process is time-consuming and hence also cost-intensive.

It is the object of the invention to create a method for producing a motor vehicle body member being formed from a flat plastics molded part as well as a corresponding motor vehicle body member in which later or separate painting is unnecessary.

In accordance with the invention, this object is attained by the method having the features of claim 1.

The invention consequently proposes a method for producing a motor vehicle body member being formed from a flat plastics molded part, comprising the following steps:
producing a fiber composite member, which is formed from a flat semifinished product being made up of fibrous material;
arranging the fiber composite member in a mold cavity of an injection tool, such that an upper side of the fiber composite member, which side is supposed to be coated, is spaced apart from a limiting surface of the mold cavity via a gap;
introducing a coating material into the gap, such that a coating is formed at the upper side of the fiber composite member, which side is supposed to be coated;
exerting a pressure on the coating material with the aid of the injection tool;
hardening the coating material, such that an outer skin of the motor vehicle body member is formed from the coating, including a high quality viewing surface; and
demolding the resulting flat plastics molded part, which is formed from the fiber composite member and from the outer skin.

Thus, the essence of the invention is that a motor vehicle body member is produced from a fiber composite member in such a manner that it is externally provided with a coating forming the outer skin, which coating does not require any additional separate painting. The coating, on grounds of its viewing surface, which is in particular formed as a so-called class A surface, rather replaces the painting that was required to date. Hence, a laborious method step during the production of motor vehicle body members that include a fiber composite member can be dropped. This becomes possible in that, with the aid of the injection tool, which can be an injection molding or a foam molding tool, high pressure is exerted on the coating material having been introduced or injected into the gap between the fiber composite member and the corresponding mold cavity. Consequently, the production of the outer skin is an embossing process, in which a high closing pressure prevails and in which the corresponding tool half is advanced onto the coating material for establishing a high pressure.

The high quality viewing surface in particular constitutes a class A surface, which is, at the very least largely, characterized by curvature continuity. Preferably, said viewing surface is a highly polished viewing surface.

In principle, the pressure that is exerted on the coating material when the same is fully cured or hardened should be as high as possible. Preferably, said pressure is at least 250 t/m². A particularly high surface quality might be achievable if the pressure is at least 1000 t/m², better still at least 1800 t/m².

In order to achieve, when closing the injection tool, sufficient ventilation while the tightness of the mold cavity, for producing the outer skin of the plastics molded part, is also sufficient, a shearing edge tool is utilized as the injection tool in a preferred embodiment of the method according to the invention.

In order to be able to produce an upper side having a sufficiently high quality on the fiber composite member to be coated, the gap between the fiber composite member and the relevant limiting surface of the mold cavity of the injection molding or foam molding tool is adjusted to dimensions between 0.02 and 2.0 mm, preferably to approximately 1.0 mm, in an expedient embodiment of the method according to the invention.

Polyurethane or polyurea materials can in particular be utilized as coating materials for the outer skin of the plastics molded part.

The coating material that is utilized, in a preferred embodiment of the method according to the invention, is transparent, at the very least after having been hardened, such that a fiber composite piece having a high surface quality is produced, in which piece the structure of the fiber composite member is visible from the outside. Hence, the outer skin forms a so-called clear coat of the plastics molded part.

It is also conceivable that the coating material is colored. The transparency can be maintained here. Alternatively, the coating material can, however, be opaque or nontransparent after having been hardened, such that the structure of the coated fiber composite member cannot show through. The upper side of such a coating has a high quality, too.

In a further preferred embodiment of the method according to the invention, the flat semifinished product being made up of fibrous material is a non-woven textile, a woven cloth or a mat being made of carbon fibers or of glass fibers. In the context of a transparent coating, a semifinished product being made up of fibrous material consisting of carbon fibers leads to a so-called viewing carbon piece.

The method according to the invention can be performed such that the fiber composite member is produced in a separate manufacturing tool. This means that the fiber composite member is initially produced in the separate manufacturing tool and is subsequently inserted into the injection tool and is provided with the coating constituting the outer skin there, namely in that the tool having the fiber composite member being inserted into the mold cavity is closed and the coating material is injected into the gap that exists after the tool has been closed. Subsequently, the tool is tightened further, such that additional pressure is exerted on the coating material. After the coating material has been hardened under pressure, the resulting flat plastics molded part can be demolded.

Alternatively, the method can be performed such that the fiber composite member is produced in the injection tool itself, namely in the mold cavity. Herein, after the fiber composite member, which consists of the flat semifinished product being made up of fibrous material and of, for example, a suitable resin, in particular of an epoxy resin, has been hardened, the tool is slightly opened, such that the gap is developed, via which the fiber composite member is spaced apart from the limiting wall of the mold cavity. Subsequently, the coating material can be injected into the gap, whereupon pressure is exerted on the injected coating material, again by tightening the tool further. Thus, an embossing process is again effected.

In accordance with the invention, a motor vehicle body member is also proposed, consisting of a flat plastics molded part, which comprises a fiber composite member, which is formed from a flat semifinished product being made up of fibrous material. The plastics molded part includes an injected, injection molded or foam molded coating forming an outer skin, which coating has directly been applied onto the fiber composite member and forms a high quality viewing surface of the plastics molded part.

The coating can be formed from a polyurethane or polyurea material.

The semifinished product being made up of fibrous material, in a preferred embodiment of the motor vehicle body member according to the invention, is a non-woven textile, a woven cloth or a mat being made of carbon fibers or of glass fibers.

Further advantages and advantageous configurations of the subject-matter of the invention can be taken from the description, from the drawing and from the claims.

One exemplary embodiment of the subject-matter of the invention is illustrated in a schematically simplified way in the drawing and will be explained in more detail in the following description. In the figures:

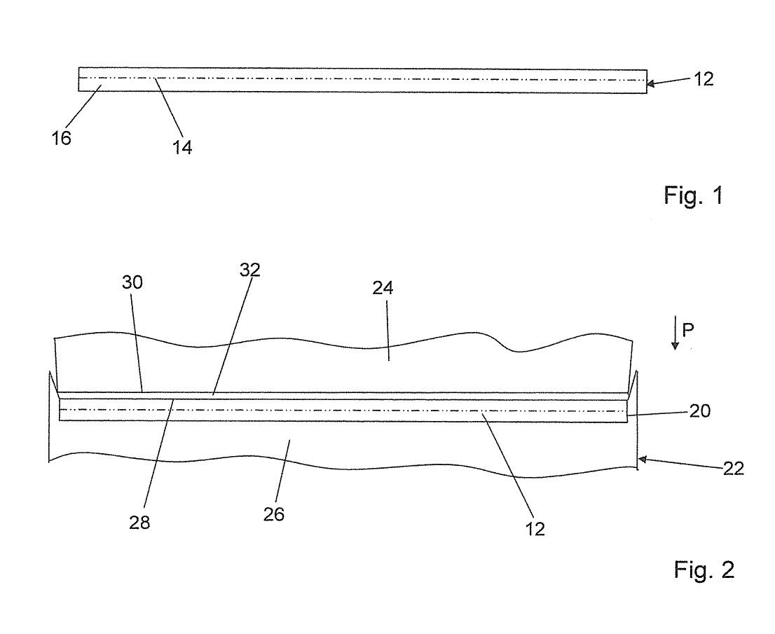

FIG. 1 shows a schematic sectional illustration through a fiber composite member;

FIG. 2 shows a section through an injection molding tool for producing a coating on the fiber composite member according to FIG. 1;

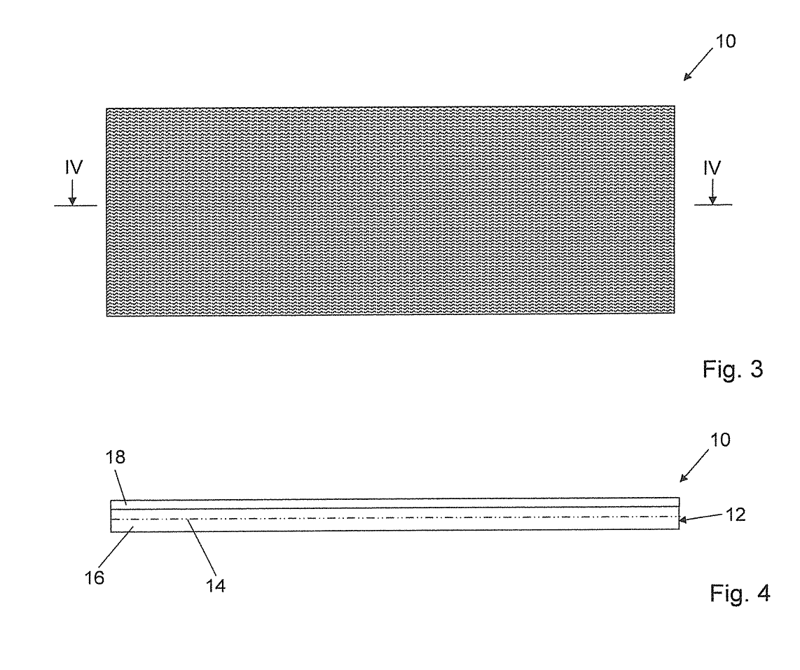

FIG. 3 shows a view from above onto the coated fiber composite member; and

FIG. 4 shows a section through the coated fiber composite member along line IV-IV in FIG. 3.

In FIGS. 3 and 4, a motor vehicle body member 10 is illustrated, which is formed as a flat plastics molded part and is, for example, a lid for a top storage compartment of a to motor vehicle being formed as a convertible vehicle. Alternatively, the motor vehicle body member according to the invention can also be a roof segment of a top of a convertible vehicle consisting of fixed-roof members (retractable hardtop; RHT), be a trunk lid, an engine hood or any other exterior paneling parts of a motor vehicle.

The motor vehicle body member 10 comprises, as a support, a fiber composite member 12, which is formed from a nonwoven textile 14 being made up of carbon fibers, said textile being embedded in a resin matrix 16. Consequently, the fiber composite member 12 constitutes a structural member being made up of carbon.

At its side facing the outer vehicle side, the fiber composite member 12 is provided with a coating, which is directly applied onto the fiber composite member 12 and is formed from a polyurethane material that is transparent when hardened. The coating, which forms an outer skin 18 of the motor vehicle body member 10, includes a highly polished surface having high quality and, on grounds of its transparency, makes it possible that the structure of the fiber composite member 12 is visible from the outer vehicle skin. The coating 18 has a thickness of approximately 0.05 mm to 1.0 mm.

The motor vehicle body member 10 being illustrated in FIGS. 3 and 4 is manufactured in the manner that is described in the following.

In a first method step, the fiber composite member 12 being illustrated in FIG. 1 is formed from a flat semifinished product being made up of carbon fibers in a separate tool and from, for example, epoxy resin. When hardened, the fiber composite member 12 is then arranged in a mold cavity 20 of an injection molding tool 22 being designed as a shearing edge tool (cf. FIG. 2). The mold cavity 20 is limited by an upper tool 24 and by a lower tool 26 of the injection molding tool 22. The fiber composite member 12, when being arranged in the mold cavity 20, rests against the limiting surface of the mold cavity 20 being formed by the lower tool 26. When the tool 22 is being closed, the upper tool 24 is advanced in the direction of the lower tool 26 such that a gap 32 of approximately 0.05 mm to 1 mm is formed between an upper side 28 of the fiber composite member 12 and a limiting surface 30 of the mold cavity 20, said limiting surface being formed by the upper tool 24 and constituting a highly polished surface. Thus, the fiber composite member 12 is then spaced apart from the limiting surface 30 of the mold cavity 20 via the gap 32.

Subsequently, a polyurethane or polyurea material is injected into the gap 32 between the fiber composite member 12 and the limiting surface 30, such that the gap 32 is filled. Afterwards, a pressure P is exerted on the material having been injected into the gap 32 by closing the injection molding tool 22 further, that means by advancing the upper tool 24 further in the direction of the lower tool 26. Said pressure is maintained when hardening the material for forming the outer skin 18 of the motor vehicle body member 10, said skin being illustrated in FIG. 3, and is approximately 250 t/m².

After hardening of the material, the finished motor vehicle body member 10 can be demolded from the injection molding tool 22.

### LIST OF REFERENCE NUMERALS

10 motor vehicle body member
12 fiber composite member
14 non-woven textile being made up of carbon fibers
16 resin matrix
18 outer skin
20 mold cavity
22 injection molding tool
24 upper tool
26 lower tool
28 upper side
30 limiting surface
32 gap

1-15. (canceled)

16. A method for producing a motor vehicle body member being formed from a flat plastics molded part, comprising the following steps:
producing a fiber composite member, which is formed from a flat semifinished product being made up of fibrous material;
arranging the fiber composite member in a mold cavity of an injection tool having an upper tool and a lower tool, such that an upper side of the fiber composite member, which side is supposed to be coated, is spaced apart from a limiting surface of the mold cavity via a gap;
introducing a coating material into the gap, such that a coating is formed at the upper side of the fiber composite member, which side is supposed to be coated; and subsequently
exerting a pressure on the coating material with the aid of the injection tool by advancing the upper tool further in the direction of the lower tool, wherein the pressure that is exerted on the coating material with the aid of the injection tool is at least 250 t/m2;
hardening the coating material, such that a transparent outer skin of the motor vehicle body member is formed from the coating, including a high quality viewing surface; and
demolding the resulting flat plastics molded part, which is formed from the fiber composite member and from the outer skin.

17. The method according to claim 16, wherein a shearing edge tool is utilized as the injection tool.

18. The method according to claim 16wherein the gap is adjusted to dimensions between approximately 0.02 mm and 2.0 mm.

19. The method according to claim 16, wherein the coating material is selected from the group consisting of a polyurethane and a polyurea material.

20. The method according to claim 16, wherein the coating material is colored.

21. The method according to claim 16, wherein the flat semifinished product being made up of fibrous material is selected from the group consisting of a nonwoven textile, a woven cloth, a carbon fibers mat and a glass fibers mat.

22. The method according to claim 16, wherein the fiber composite member is produced in a separate manufacturing tool.

23. The method according to claim 16, wherein the fiber composite member is produced in the mold cavity of the injection tool.

24. A motor vehicle body member having a flat plastics molded part having a fiber composite member formed from a flat semifinished product being made up of fibrous material, comprising: an outer skin of the fiber composite member formed by a transparent coating, the transparent coating being directly applied onto the fiber composite member wherein a high quality viewing surface of the plastics molded part is formed.

25. The motor vehicle body member according to claim 24, wherein the coating is formed from a material selected from the group consisting of polyurethane and polyurea.

26. The motor vehicle body member according to claim 24, wherein the coating is colored.

27. The motor vehicle body member according to claim 24, wherein the semifinished product being made up of fiber composite material is selected from the group consisting of a nonwoven textile, a woven cloth, a carbon fibers mat and a glass fibers mat.
